(19) United States
(12) Patent Application Publication
(10) Pub. No.: US 2025/0020560 A1
(43) Pub. Date: Jan. 16, 2025

(54) STIFFNESS MEASURING APPARATUS AND IMAGE FORMING SYSTEM

(71) Applicant: Konica Minolta, Inc., Tokyo (JP)

(72) Inventor: Bowen YANG, Tokyo (CN)

(21) Appl. No.: 18/768,726

(22) Filed: Jul. 10, 2024

(30) Foreign Application Priority Data
Jul. 12, 2023 (JP) 2023-114557

(51) Int. Cl. G01N 3/42; G01N 3/04

(52) U.S. Cl. CPC G01N 3/42; G01N 3/04; G01N 2203/0037; G01N 2203/0282; G01N 2203/0405

(57) ABSTRACT

A stiffness measuring apparatus includes: a pinching member that pinches a recording material such that a recording surface of the recording material is substantially parallel to a vertical direction; a presser that presses the recording surface of the recording material pinched by the pinching member, and a stiffness acquirer that measures a reaction force of the recording material when the recording surface of the recording material is pressed by the presser, and acquires the measured reaction force as stiffness of the recording material. Portions of the pinching member that pinch the recording material are formed of materials having the same hardness.

### CROSS-REFERENCE TO RELATED APPLICATION

The present invention claims priority under 35 U.S.C. § 119 to Japanese patent Application No. 2023-114557, filed on Jul. 12, 2023, the entire content of which is incorporated herein by reference.

### BACKGROUND OF THE INVENTION

### 1. Technical Field

The present invention relates to a stiffness measuring apparatus and an image forming system.

### 2. Description of Related Art

In an image forming apparatus for forming an image on a sheet which is a recording medium, a technique is known in which the stiffness of a recording material such as a sheet is detected and various control parameters are set based on the result of the detection. For example, stiffness data of the recording material is fed back to transfer conditions. Japanese Unexamined Patent Application Publication No. 2010-049178 describes a technique for detecting the stiffness of a sheet. The image forming apparatus described in Japanese Unexamined Patent Application Publication No. 2010-049178 presses a sheet being conveyed against a lever, and detects, as the stiffness of the sheet, an amount of shift of the lever at the time of the pressing.

### SUMMARY OF THE INVENTION

However, the image forming apparatus described in Japanese Unexamined Patent Application Publication No. 2010-049178 holds a sheet being horizontally conveyed at a predetermined position and measures the stiffness of the sheet. Therefore, the result of measuring the stiffness includes the effect of gravity applied to the sheet. Therefore, the image forming apparatus described in Japanese Unexamined Patent Application Publication No. 2010-049178 has a problem that the stiffness of the sheet cannot be accurately measured.

In order to cancel the effect of gravity, for example, it is conceivable to lift the sheet by an amount by which the sheet droops due to the effect of gravity. However, it is difficult to lift, with high accuracy, the sheet by the amount by which the sheet droops due to the effect of gravity. Further, as a distance from a portion where the sheet is held to the lever increases, the effect of gravity increases, and therefore, it is difficult to accurately grasp the effect of gravity necessary for cancellation.

Objects of the present invention are to provide a stiffness measuring apparatus and an image forming system capable of measuring the stiffness of a recording material such as a sheet with high accuracy.

In order to achieve at least one of the above-described objects, a stiffness measuring apparatus according to one aspect of the present invention includes a pinching member, a presser, and a stiffness acquirer. The pinching member pinches a recording material such that a recording surface of the recording material is substantially parallel to a vertical direction. The presser presses the recording surface of the recording material pinched by the pinching member. The stiffness acquirer measures a reaction force of the recording material when the recording surface of the recording material is pressed by the presser and acquires the measured reaction force as stiffness of the recording material. Portions of the pinching member that pinch the recording material are formed of materials having the same hardness.

An image forming system according to one aspect of the present invention includes: an image former that forms an image on a recording material; a recording material storage portion that can store the recording material; and a recording material conveyance section provided between the recording material storage portion and the image former. Further, the image forming system includes: the stiffness measuring apparatus that is installed in the recording material conveyance section and measures stiffness of the recording material; and a controller that sets an image forming parameter in accordance with a result of the measurement by the stiffness measuring apparatus.

### BRIEF DESCRIPTION OF THE DRAWINGS

The advantages and features provided by one or more embodiments of the invention will become more fully understand from the detailed description given hereinbelow and the appended drawings which are given by way of illustration only, and thus are not intended as a definition of the limits of the present invention.

FIG. 1 is a diagram illustrating a schematic configuration of an image forming system according to an embodiment.

FIG. 2 is a system block diagram of the image forming system according to the embodiment.

FIG. 3 is a functional block diagram of a controller in the image forming system according to the embodiment.

FIG. 4 is a diagram illustrating a schematic configuration of a stiffness measuring apparatus according to an embodiment.

FIG. 5 is a view of a pair of holding rollers of the stiffness measuring apparatus from above.

FIG. 6 is a block diagram illustrating an example of a configuration of a control system of the stiffness measuring apparatus according to the embodiment.

FIG. 7 is a diagram for explaining a plurality of pinching members of the stiffness measuring apparatus.

FIG. 8 is a diagram illustrating a state in which a presser of the stiffness measuring apparatus presses a recording material.

FIG. 9A and FIG. 9B are diagrams illustrating a state in which the presser presses the recording material in a case where a pinching force of a pinching member in the stiffness measuring apparatus is insufficient.

FIG. 10 is a diagram illustrating a state in which the presser presses the recording material in a case where a distance from the pinching member to a lower end of the recording material is equal to or greater than a predetermined distance in the stiffness measuring apparatus.

FIG. 11 is a diagram illustrating pinching forces of the plurality of pinching members in the stiffness measuring apparatus.

FIG. 12 is a flowchart illustrating a procedure of a parameter setting process by the image forming system according to a first embodiment of the present invention.

FIG. 13 is a diagram illustrating a modification example of the pinching member in the stiffness measuring apparatus.

### DETAILED DESCRIPTION

Hereinafter, one or more embodiments of the present invention will be described with reference to the drawings. However, the scope of the invention is not limited to the disclosed embodiments.

In this specification and drawings, constituent elements which are substantially the same are denoted by the same reference signs and redundant description is omitted.

### Configuration of Image Forming System

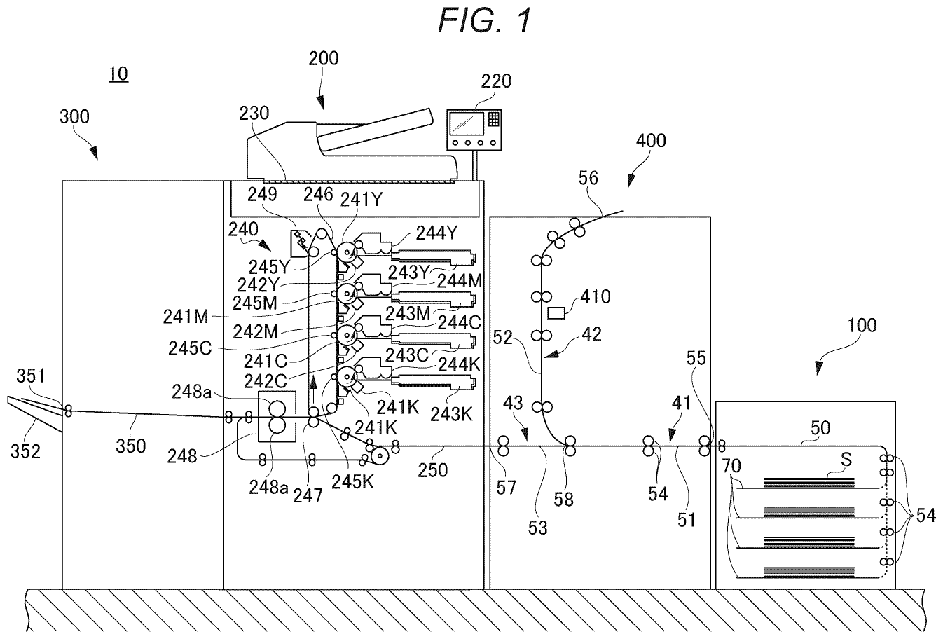

First, a configuration of an image forming system according to an embodiment will be described with reference to FIG. 1.

FIG. 1 is a diagram illustrating a schematic configuration of the image forming system according to the embodiment.

As illustrated in FIG. 1, the image forming system 10 includes a recording material supply apparatus 100, a recording material conveyance apparatus 400, an image forming apparatus 200, and a post-processing apparatus 300.

In a case where an image is formed on a recording material S in the image forming system 10, first, the recording material S is supplied to the recording material conveyance apparatus 400 from the recording material supply apparatus 100. Then, the recording material conveyance apparatus 400 conveys the recording material S to the image forming apparatus 200. The recording material conveyance apparatus 400 includes a stiffness measuring apparatus 410 that measures the stiffness of the recording material S.

Next, the image forming apparatus 200 forms an image on the recording material S supplied from the recording material conveyance apparatus 400. Then, the image forming apparatus 200 sends the recording material S on which the image has been formed to the post-processing apparatus 300. The post-processing apparatus 300 performs predetermined post-processing on the recording material S on which the image has been formed. Thereafter, the post-processing apparatus 300 ejects the recording material S.

### Recording Material Supply Apparatus

The recording material supply apparatus 100 stores recording materials S for image formation. Upon receiving an image forming job from a below-described controller 90 of the image forming system 10, the recording material supply apparatus 100 supplies a recording material S corresponding to the image forming job to the recording material conveyance apparatus 400. The recording material supply apparatus 100 includes a conveyance section 50 and a recording material supply section 70.

The recording material supply section 70 includes a plurality of recording material storage portions. Recording materials S different in type and size are individually stored in the plurality of recording material storage portions. In the present embodiment, each recording material S is a recording medium on which an image is formed, and is, for example, a sheet. The recording material S may be any material other than a sheet as long as the stiffness of the recording material S can be measured.

The conveyance section 50 includes a plurality of take-out rollers for taking out a recording material S from the recording material supply section 70, and a plurality of conveying rollers 54. In FIG. 1, a plurality of take-out rollers are not illustrated. The plurality of conveying rollers 54 are arranged in a predetermined recording material conveyance path. The plurality of conveying rollers 54 convey recording materials S taken out from the recording material supply section 70 to the recording material conveyance apparatus 400 one by one.

### Recording Material Conveyance Apparatus

The recording material conveyance apparatus 400 includes an inlet port 55, a first conveyance section 51, a second conveyance section 52, a third conveyance section 53, an ejection section 56, an outlet port 57, and the stiffness measuring apparatus 410.

A recording material S supplied from the recording material supply apparatus 100 through the inlet port 55 is carried into the recording material conveyance apparatus 400. The first conveyance section 51, the second conveyance section 52, and the third conveyance section 53 convey the recording material S carried in from the inlet port 55 to the ejection section 56 or the outlet port 57. The first conveyance section 51, the second conveyance section 52, and the third conveyance section 53 correspond to a recording material conveyance section according to the present invention. The first conveyance section 51, the second conveyance section 52, and the third conveyance section 53 include a plurality of conveying rollers 54 for conveying a recording material S.

The recording material conveyance apparatus 400 includes a branch portion 58 that branches a conveyance path for the recording material S. The recording material conveyance apparatus 400 includes a first conveyance path 41 located upstream of the branch portion 58 in a recording material conveyance direction, and a second conveyance path 42 and a third conveyance path 43 located downstream of the branch portion 58 in the recording material conveyance direction.

The first conveyance path 41 is a path from the inlet port 55 to the branch portion 58. The first conveyance section 51 is disposed in the first conveyance path 41. The first conveyance section 51 conveys the recording material S along the first conveyance path 41. The recording material S conveyed along the first conveyance path 41 is guided to the second conveyance path 42 or the third conveyance path 43 by the branch portion 58.

The second conveyance path 42 is a path from the branch portion 58 to the ejection section 56. The second conveyance section 52 is disposed in the second conveyance path 42. The second conveyance section 52 conveys the recording material S along the second conveyance path 42. The recording material S conveyed along the second conveyance path 42 is ejected from the ejection section 56.

The third conveyance path 43 is a path from the branch portion 58 to the outlet port 57. The third conveyance section 53 is disposed in the third conveyance path 43. The third conveyance section 53 conveys the recording material S along the third conveyance path 43. The recording material S conveyed along the third conveyance path 43 is ejected from the outlet port 57. The recording material S ejected from the outlet port 57 is supplied to the image forming apparatus 200.

The stiffness measuring apparatus 410 is disposed in the second conveyance path 42. The stiffness measuring apparatus 410 is an apparatus that measures the stiffness of the recording material S. The stiffness of the recording material S is an index indicating resistance when the recording material S is bent and can be expressed using various physical quantities. The stiffness measuring apparatus 410 measures the stiffness of the recording material S stopped being conveyed in the middle of the second conveyance path 42. Hereinafter, a position where the stiffness of the recording material S is measured is referred to as a “stiffness measurement position”. The stiffness measurement position corresponds to a predetermined position according to the present invention.

### Image Forming Apparatus

The image forming apparatus 200 includes an operation display part 220, a scanner 230, an image former 240, and a conveyance section 250.

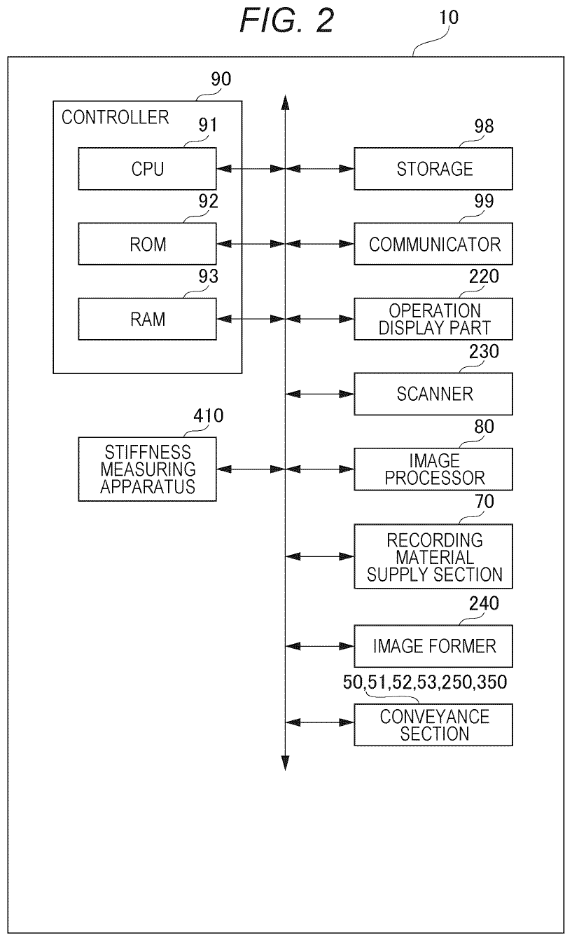

The operation display part 220 includes an operation part and a display part. The display part is, for example, a display device such as a liquid crystal display (LCD). The display part displays various screens in accordance with an instruction of a display signal input from a controller 90 (see FIG. 2) to be described later. The operation part includes a touch screen formed so as to cover a display screen of the display part, and various operation buttons such as numeric buttons and a start button. The operation part accepts an operation instruction from a user. The operation part outputs an operation signal based on a user operation to the controller 90 which will be described later.

The scanner 230 includes an automatic document feeder (ADF) and a document image scanning device which is a scanner. The automatic document feeder conveys a document placed on a document tray by a conveyance mechanism and sends the document to the document image scanning device. The document image scanning device optically scans the document conveyed onto a contact glass by the automatic document feeder or the document placed on the contact glass by the user and reads an image of the document by forming an image of reflected light from the document on a light receiving surface of a charge coupled device (CCD) sensor or the like. The scanner 230 generates image data based on a result of the reading by the document image scanning device.

The image former 240 forms an image on the recording material S based on the image data. The image former 240 includes photosensitive drums 241Y, 241M, 241C, and 241K, chargers 242Y, 242M, 242C, and 242K, exposure sections 243Y, 243M, 243C, and 243K, developing sections 244Y, 244M, 244C, and 244K, and primary transfer rollers 245Y, 245M, 245C, and 245K corresponding to respective colors of yellow (Y), magenta (M), cyan (C), and black (K). The image former 240 further includes an intermediate transfer belt 246, a secondary transfer roller 247, and a fixer 248.

Hereinafter, the photosensitive drums 241Y, 241M, 241C, and 241K are collectively referred to as a “photosensitive drum 241”. The chargers 242Y, 242M, 242C, and 242K are collectively referred to as a “charger 242”, and the exposure sections 243Y, 243M, 243C, and 243K are collectively referred to as an “exposure section 243”. Further, the developing sections 244Y, 244M, 244C, and 244K are collectively referred to as a “developing section 244”, and the primary transfer rollers 245Y, 245M, 245C, and 245K are collectively referred to as a “primary transfer roller 245”.

The photosensitive drum 241 is an image bearing member that carries a toner image thereon. The photosensitive drum 241 is driven to rotate by a photosensitive drum drive motor (not illustrated). Around the photosensitive drum 241, the charger 242, the exposure section 243, and the developing section 244 are arranged in this order from upstream to downstream in a rotation direction of the photosensitive drum 241. The charger 242 uniformly charges the photosensitive drum 241.

The exposure section 243 includes a laser light source, a polygon mirror, a lens, and the like. The exposure section 243 scans and exposes the surface of the photosensitive drum 241 with a laser beam to form an electrostatic latent image. The scanning and the exposure are performed by the exposure section 243 based on image data read by the scanner 230 or image data received from an external device.

The developing section 244 develops the electrostatic latent image formed on the photosensitive drum 241 by attaching toner of each color to the electrostatic latent image. Thus, a toner image is formed on the image bearing surface of the photosensitive drum 241. That is, a yellow toner image is formed on the image bearing surface of the photosensitive drum 241Y. A magenta toner image is formed on the image bearing surface of the photosensitive drum 241M. A cyan toner image is formed on the image bearing surface of the photosensitive drum 241C. A black toner image is formed on the image bearing surface of the photosensitive drum 241K.

The intermediate transfer belt 246 is looped over a plurality of belt support rollers. The primary transfer roller 245, the secondary transfer roller 247, a static eliminating roller (not illustrated), and a cleaning unit 249 are arranged on a movement path of the intermediate transfer belt 246.

The outer circumferential surface of the intermediate transfer belt 246 serves as an image bearing surface. The outer circumferential surface of the intermediate transfer belt 246 is in contact with the outer peripheral surface of the photosensitive drum 241. The intermediate transfer belt 246 rotates in the opposite direction to the rotation of the photosensitive drum 241. Specifically, the photosensitive drum 241 rotates counterclockwise in FIG. 1, and the intermediate transfer belt 246 rotates clockwise in FIG. 1.

The primary transfer roller 245 is disposed at a position facing the photosensitive drum 241. The primary transfer roller 245 is disposed on the inner circumferential side of the intermediate transfer belt 246. The primary transfer roller 245 and the opposing photosensitive drum 241 pinch the intermediate transfer belt 246 therebetween.

The primary transfer roller 245 transfers the toner deposited on the image bearing surface of the photosensitive drum 241 onto the image bearing surface of the intermediate transfer belt 246 by providing the intermediate transfer belt 246 with an electric charge having a polarity opposite to that of the toner. As a result, a color toner image in which the toner images of the four colors are superimposed is formed on the image bearing surface of the intermediate transfer belt 246.

The secondary transfer roller 247 collectively transfers the color toner image on the image bearing surface of the intermediate transfer belt 246 onto one recording surface of the recording material S. The secondary transfer roller 247 and the belt support roller pinch the intermediate transfer belt 246. A position where the secondary transfer roller 247 and the belt support roller face each other is a transfer position where the toner image transferred to the image bearing surface of the intermediate transfer belt 246 is transferred onto the recording material S.

The cleaning unit 249 is disposed upstream of the primary transfer roller 245 and downstream of the static eliminating roller (not illustrated) in the rotation direction of the intermediate transfer belt 246. The cleaning unit 249 removes toner remaining on the image bearing surface of the intermediate transfer belt 246.

The fixer 248 includes a pair of rollers 248a and 248a. One roller 248a of the pair of rollers 248a and 248a is a fixing roller, and the other roller 248a is a pressure roller. The fixing roller has a built-in heater. The pressure roller is pressed against the fixing roller. Thus, the fixing roller and the pressure roller are brought into pressure contact with each other and a fixing nip portion is formed at this pressure contact portion where the fixing roller and the pressure roller are brought into pressure contact with each other. The recording material S is heated and pressurized when passing through the fixing nip portion. Thus, the toner image transferred onto the recording material S is fixed.

The conveyance section 250 includes a plurality of conveying rollers 54 for conveying the recording material S along a predetermined conveyance path. The conveyance section 250 conveys the recording material S supplied from the recording material conveyance apparatus 400 to the transfer position. Further, the conveyance section 250 conveys the recording material S after image formation to the post-processing apparatus 300.

### Post-Processing Apparatus

The recording material S on which an image has been formed by the image forming apparatus 200 is conveyed into the post-processing apparatus 300. The post-processing apparatus 300 includes a plurality of post-processing units, a conveyance section 350, an ejection section 351, and a sheet ejection tray 352.

Upon receiving a post-processing job from the controller 90 which will be described later, the post-processing apparatus 300 executes predetermined post-processing in a post-processing unit designated in the post-processing job among the plurality of post-processing units. Examples of the post-processing include perforation processing, folding processing, foil stamping, binding, cutting processing, stapling, gluing, and binding.

The conveyance section 350 includes a plurality of conveying rollers (not illustrated) for conveying the recording material S along a predetermined conveyance path. The conveyance section 350 conveys the recording material S supplied from the image forming apparatus 200 to a post-processing unit corresponding to the type of post-processing to be executed. Further, the conveyance section 350 conveys the recording material S subjected to the post-processing and ejects the recording material S from the ejection section 351. The recording material S ejected from the ejection section 351 is placed on the sheet ejection tray 352.

### System Block Diagram

Next, an example of the configuration of the control system of the image forming system 10 will be described referring to FIG. 2.

FIG. 2 is a system block diagram of the image forming system 10.

As illustrated in FIG. 2, the image forming system 10 includes the controller 90, a storage 98, a communicator 99, the operation display part 220, the scanner 230, an image processor 80, the recording material supply section 70, the image former 240, the conveyance sections 51, 52, 53, 250, and 350, and the stiffness measuring apparatus 410. Hereinafter, a description of the configuration that overlaps with the description of the image forming system 10 illustrated in FIG. 1 described above will be omitted.

The controller 90 includes, for example, a central processing unit (CPU) 91, a read only memory (ROM) 92, and a random access memory (RAM) 93. Various functions of the controller 90 are implemented by the CPU 91 executing a predetermined processing program stored in the ROM 92. The various functions of the controller 90 include, for example, control of driving of the recording material supply section 70, control of driving of the conveyance sections 50, 51, 52, 53, 250, and 350, and control of each operation relating to image formation of the image former 240.

The ROM 92 stores various processing programs for controlling each part of the image forming system 10, parameters and table data necessary for executing the programs, various files, and the like. The ROM 92 is used as an example of a non-transitory recording medium storing a computer-readable program to be executed by the CPU 91. For this reason, this program is permanently stored in the ROM 92.

The RAM 93 is, for example, a volatile semiconductor memory. The RAM 93 forms a work area for temporarily storing various processing programs read from the ROM 92, input data or output data, parameters, and the like in various processes executed and controlled by the CPU 91.

The storage 98 stores, for example, image data or the like received from an external device. In addition, the storage 98 stores various processing programs to be executed by the CPU 91, information regarding processing functions of the apparatus that are necessary for executing the programs, image data read by the scanner 230, image data input from a client apparatus (not illustrated), stiffness information of the recording material S acquired by the stiffness measuring apparatus 410, and the like. The storage 98 is, for example, a nonvolatile memory such as a hard disk drive (HDD), a solid state drive (SSD), or a flash memory.

The communicator 99 includes a network interface card (NIC), a modem, and the like. The communicator 99 connects the recording material supply apparatus 100, the recording material conveyance apparatus 400, the image forming apparatus 200, the post-processing apparatus 300, and the stiffness measuring apparatus 410 to a communication network such as a local area network (LAN) or a wide area network (WAN). The communicator 99 transmits various types of data to an external information device. Further, the communicator 99 receives various data from the external information device. The external information device is, for example, a client device.

As described above, the operation display part 220 functions as the display part and the operation unit. The display part displays various operation screens in accordance with a display control signal input from the controller 90. The operation part accepts various kinds of input operation by the user, and outputs an operation signal corresponding to the various kinds of input operation to the controller 90.

The scanner 230 outputs a read analog image signal to the image processor 80.

The image processor 80 includes a circuit that performs analog-to-digital (AD) conversion and a circuit that performs digital image processing. The image processor 80 performs A/D conversion processing on the analog image signal supplied from the scanner 230 to generate digital image data. Further, the image processor 80 analyzes a print job acquired from the external information device and rasterizes each page of a document to generate digital image data. Further, the image processor 80 performs image processing, such as color conversion processing, correction processing corresponding to initial setting or user setting, and compression processing, on the image data, as necessary. The correction corresponding to the user setting is, for example, shading correction. The image processor 80 outputs the image data after the image processing to the image former 240.

The stiffness measuring apparatus 410 is disposed in the recording material conveyance apparatus 400 (see FIG. 1). The stiffness measuring apparatus 410 transmits a measurement result to the controller 90.

### Functional Configuration of Controller

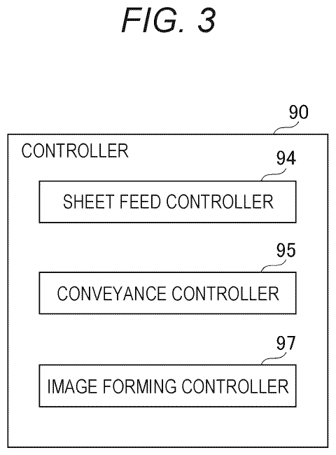

Next, a functional configuration of the controller 90 is described with reference to FIG. 3.

FIG. 3 is a functional block diagram of the controller 90.

As illustrated in FIG. 3, the controller 90 includes a sheet feed controller 94, a conveyance controller 95, and an image forming controller 97.

The sheet feed controller 94 controls the driving of the recording material supply section 70 of the recording material supply apparatus 100 to supply the recording material S from the recording material supply section 70 to the conveyance section 50. The recording material supply section 70 supplies the recording material S to the conveyance section 50 in accordance with control of the conveyance of the recording material S by the conveyance controller 95.

The conveyance controller 95 controls driving of the conveyance sections 50, 51, 52, 53, 250, and 350 provided in the recording material supply apparatus 100, the recording material conveyance apparatus 400, the image forming apparatus 200, and the post-processing apparatus 300. As a result, the recording material S is conveyed to each portion of the image forming system 10.

Further, the conveyance controller 95 controls a conveyance mechanism such as the branch portion 58 of the recording material conveyance apparatus 400 to change the conveyance path for the recording material S.

When a plurality of recording materials S are conveyed in accordance with an image forming job, the conveyance controller 95 guides at least one of the recording materials S to the second conveyance path 42 of the recording material conveyance apparatus 400. The second conveyance path 42 is a path along which the second conveyance section 52 conveys the recording material S. In the second conveyance path 42, the stiffness measuring apparatus 410 measures the stiffness of the recording material S and acquires stiffness information based on a result of measuring the stiffness of the recording material S. A surface property detector that detects the surface property of the recording material S and a resistance value detector that detects the resistance value of the recording material S may be further provided in the second conveyance path 42.

Further, the conveyance controller 95 corrects a control parameter regarding the conveyance of the recording material S in accordance with the stiffness of the recording material S. A specific example of the control parameter regarding the conveyance is the speed at which the recording material S is conveyed.

The image forming controller 97 controls an image forming operation of the image former 240. Further, the image forming controller 97 determines a control parameter regarding image formation in accordance with the stiffness of the recording material S measured by the stiffness measuring apparatus 410. Specific examples of the control parameter regarding the image formation include a potential to be charged by the charger 242, a transfer current to be supplied to the primary transfer roller 245 and the secondary transfer roller 247, and a fixing temperature and a fixing pressure in the fixer 248.

### Configuration of Stiffness Measuring Apparatus

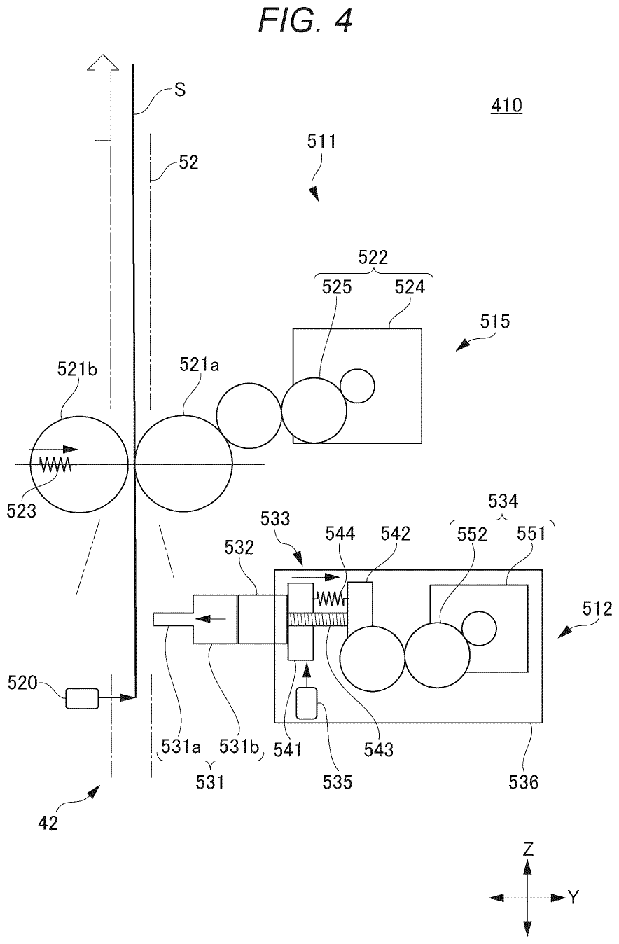

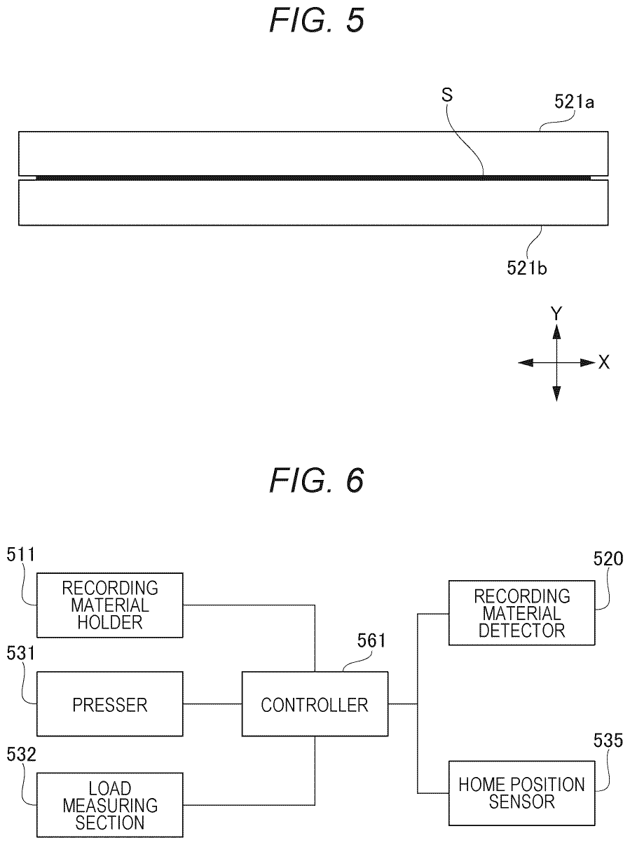

Next, the configuration of the stiffness measuring apparatus 410 will be described with reference to FIGS. 4 and 5.

FIG. 4 is a diagram illustrating a schematic configuration of the stiffness measuring apparatus 410. FIG. 5 is a view of a pair of holding rollers of the stiffness measuring apparatus 410 from above.

As illustrated in FIG. 4, the stiffness measuring apparatus 410 is disposed in the second conveyance path 42 along which the second conveyance section 52 conveys the recording material S. In the second conveyance path 42, a conveyance direction of the recording material S is a vertical direction Z. The stiffness measuring apparatus 410 stops the recording material S being conveyed in the vertical direction Z and measures the stiffness of the recording material S.

Thereafter, the direction in which the recording material S is conveyed is the vertical direction Z. A direction orthogonal to the recording surface of the recording material S conveyed along the second conveyance path 42 is a horizontal direction Y, and a direction orthogonal to the vertical direction Z and the horizontal direction Y is a recording material width direction X.

The stiffness measuring apparatus 410 includes a recording material holder 511 that holds the recording material S and a stiffness measuring section 512 that measures the stiffness of the recording material S held by the recording material holder 511.

The recording material holder 511 is constituted by a plurality of pinching members 515. FIG. 4 illustrates only the pinching member 515 closest to the lower end of the recording material S among the plurality of pinching members 515. Each of the pinching members 515 includes a pair of holding rollers 521a and 521b, a roller driving section 522, and a biasing spring 523.

Rotation shafts of the pair of holding rollers 521a and 521b are parallel to the recording material width direction X. As illustrated in FIG. 5, the lengths (widths) of the pair of holding rollers 521a and 521b in the X direction are longer than the length (width) of the recording material S in the X direction. Therefore, the pair of holding rollers 521a and 521b holds the recording material S over the entire width in the X direction.

It is preferable that the pair of holding rollers 521a and 521b also serve as conveying rollers. The roller driving section 522 rotates the holding roller 521a. The roller driving section 522 includes a holding roller motor 524 and a gear train 525 for transmitting the rotation of the holding roller motor 524 to the holding roller 521a.

The biasing spring 523 biases the holding roller 521b to the holding roller 521a side. The direction in which the biasing spring 523 biases the holding roller 521b is the horizontal direction Y. The pair of holding rollers 521a and 521b pinches the recording material S with a predetermined pinching force. The pair of holding rollers 521a and 521b pinches the recording material S in a posture in which the recording surface is substantially parallel to the vertical direction Z.

In the second conveyance path 42, a recording material detector 520 is arranged. The recording material detector 520 detects the lower end of the recording material S when the recording material S is placed at the stiffness measurement position. The recording material detector 520 outputs a result of the detection, that is, a result indicating that the lower end of the recording material S has been detected to a controller 561 (see FIG. 6) of the stiffness measuring apparatus 410. The controller 561 will be described later. Thus, the controller 561 detects that the recording material S has been placed at the stiffness measurement position.

The stiffness measuring section 512 is disposed below the pair of holding rollers 521a and 521b of the pinching member 515 closest to the lower end of the recording material S. The stiffness measuring section 512 includes a presser 531, a load measuring section 532, a support mechanism 533, a moving mechanism 534, a home position sensor 535, and a frame 536. The support mechanism 533, the moving mechanism 534, and the home position sensor 535 are disposed in the frame 536.

The presser 531 presses the lower end of the recording material S. The presser 531 includes a blade 531a and a base 531a contiguous to one end of the blade 531b in the horizontal direction Y. The blade 531a is formed in a plate-like shape that is long in the recording material width direction X so as to be able to contact the entire width of the recording material S conveyed in the vertical direction Z. The blade 531a comes into contact with a measurement point at a position separated by a specific distance from the lower end of the recording material S to the blade 531a on the upper side in the vertical direction Z. That is, the measurement point is located vertically below a portion of the recording material S held by the recording material holder 511.

The load measuring section 532 is connected to a surface of the presser 531 opposite to a surface of the base 531b contiguous to the blade 531a. The load measuring section 532 measures a load of a reaction force when the recording material S is pressed and bent by the presser 531. As the load measuring section 532, for example, a load cell or a pressure sensor can be adopted.

The support mechanism 533 movably supports the presser 531 and the load measuring section 532 in the horizontal direction Y. That is, the direction in which the presser 531 presses the recording material S is parallel to the direction in which the pinching force of the pinching member 515 closest to the lower end of the recording material S acts. The support mechanism 533 includes a detector holding member 541, an abutting member 542, a worm gear 543, and a biasing spring 544. The detector holding member 541 and the abutting member 542 are attached to the frame 536.

The detector holding member 541 is supported by the frame 536 so as to be movable in the horizontal direction Y.

Further, the frame 536 is provided with a locking section (not illustrated) that locks rotation of the detector holding member 541 about an axis extending in the horizontal direction Y. The detector holding member 541 holds the load measuring section 532. A surface of the load measuring section 532 opposite to a surface connected to the presser 531 is connected to the detector holding member 541.

The abutting member 542 faces the detector holding member 541 in the horizontal direction Y. The abutting member 542 is fixed to the frame 536. The abutting member 542 rotatably supports one end of the worm gear 543.

A rotation shaft of the worm gear 543 extends in the horizontal direction Y. The movement of the worm gear 543 in the horizontal direction Y is locked by the abutting member 542. The other end of the worm gear 543 is screwed into the detector holding member 541. Thus, when the worm gear 543 rotates, the detector holding member 541 moves in the horizontal direction.

The biasing spring 544 is connected to the detector holding member 541 and the abutting member 542. The biasing spring 544 biases the detector holding member 541 toward the abutting member 542. As the biasing spring 544, for example, a tension coil spring or a compression coil spring can be adopted.

Backlash occurs between the detector holding member 541 and the worm gear 543. Therefore, the detector holding member 541 is slightly movable in the horizontal direction Y regardless of the rotation of the worm gear 543. In the present embodiment, since the biasing spring 544 is provided, the detector holding member 541 does not move to the abutting member 542 side even by the effect of the backlash. Thus, in a case where the stiffness of the recording material S is measured, the detector holding member 541 and the presser 531 are not shifted to the abutting member 542 side. As a result, the stiffness measuring apparatus 410 can measure the stiffness of the recording material S with high accuracy.

The moving mechanism 534 moves the presser 531 in the horizontal direction Y via the support mechanism 533.

The moving mechanism 534 includes a recording material pressing motor 551 and a gear train 552 that transmits the rotation of the recording material pressing motor 551 to the worm gear 543. As the recording material pressing motor 551, for example, a stepping motor can be adopted.

The home position sensor 535 detects home positions of the detector holding member 541 and the presser 531. The home position of the presser 531 is a position at which the presser 531 starts to contact the recording surface of the recording material S. The home position sensor 535 detects the home position of the presser 531 from the position of the detector holding member 541.

The home position of the presser 531 varies depending on the thickness of the recording material S. For the association of the thickness of the recording material S and the home position, table data stored in a storage 564 (see FIG. 6) in advance may be used. The load measuring section 532 measures a load (pressing force) received from the recording material S when the presser 531 moves to the recording material S side in the horizontal direction Y from the home position by a predetermined amount.

### Functional Configuration of Stiffness Measuring Apparatus

Next, a functional configuration of the stiffness measuring apparatus 410 will be described with reference to FIG. 6.

FIG. 6 is a block diagram illustrating an example of a configuration of a control system of the stiffness measuring apparatus 410.

As illustrated in FIG. 6, the stiffness measuring apparatus 410 includes the controller 561. The controller 561 includes a central processing unit (CPU), a read only memory (ROM), and a random access memory (RAM). Various functions of the controller 561 are implemented by the CPU executing a predetermined processing program stored in the ROM. The ROM is used as an example of a non-transitory recording medium storing a computer-readable program to be executed by the CPU. Therefore, the program is permanently stored in the ROM.

The controller 561 controls the holding roller motor 524 of the recording material holder 511, the recording material pressing motor 551 of the presser 531, and the load measuring section 532. Further, the controller 561 is electrically connected to the recording material detector 520 and the home position sensor 535 in a wired or wireless manner. In a case where each of the pairs of holding rollers 521a and 521b (see FIG. 4) also serves as the conveying rollers, the holding roller motor 524 may be controlled by the conveyance controller 95 (sec FIG. 3).

The stiffness measuring apparatus 410 measures the stiffness (load) of the recording material S by operating as follows.

First, the controller 561 receives a detection result of the recording material detector 520 and detects that the recording material S has been placed at the stiffness measurement position. Next, the controller 561 controls the driving of the holding roller motor 524 to cause the recording material holder 511 to hold the recording material S placed at the stiffness measurement position. In this case, each of the pairs of holding rollers 521a and 521b holds the recording material S over the entire width (see FIG. 5). The recording material S held by the recording material holder 511 is in a posture in which the recording surface is substantially perpendicular to the horizontal direction Y.

Next, the controller 561 controls the driving of the recording material pressing motor 551 to move the presser 531 and the load measuring section 532 in the horizontal direction Y via the detector holding member 541. Thus, the presser 531 starts to contact the recording surface of the recording material S. In this case, the home position sensor 535 detects the position of the detector holding member 541 and outputs the result of the detection to the controller 561. Thus, the controller 561 detects the home positions of the presser 531 and the detector holding member 541. The controller 561 may use the table data stored in advance in the storage 564 to determine distances that the presser 531 and the detector holding member 541 are moved to the home positions.

Next, the controller 561 controls the driving of the recording material pressing motor 551 to move the presser 531 from the home position to a measurement end position. The distance from the home position to the measurement end position is, for example, 4 mm. The presser 531 that moves from the home position to the measurement end position presses and bends the recording material S. In this case, the load measuring section 532 measures a load (pressing force) of a reaction force received from the recording material S, and outputs the measured load to the controller 561. Thus, the controller 561 acquires the load of the reaction force of the recording material S.

After acquiring the load of the reaction force of the recording material S, the controller 561 releases the pressed state of the recording material S by the presser 531. That is, the controller 561 controls the driving of the recording material pressing motor 551 to move the presser 531 to the abutting member 542 (see FIG. 4) side with respect to the home position. Thus, the pressed state of the recording material S by the presser 531 is released.

The controller 561 calculates the stiffness information corresponding to the stiffness of the recording material S based on the load measured when the presser 531 moves from the home position to the predetermined position. In the present embodiment, the stiffness information is an amount of change per unit distance in the load measured by the load measuring section 532. The controller 561 transmits the calculated stiffness information to the controller 90 of the image forming system 10.

As described above, the presser 531 presses, in the horizontal direction Y, the recording material S whose recording surface is substantially perpendicular to the horizontal direction Y. Therefore, the effect of gravity can be minimized when the recording material S is pressed. As a result, the stiffness of the recording material S can be measured with high accuracy.

### Plurality of Pinching Members

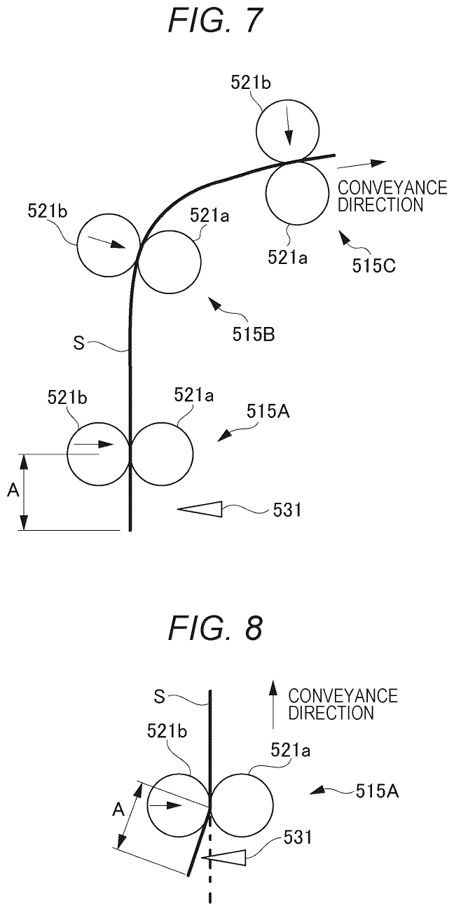

Next, the plurality of pinching members 515 will be described with reference to FIG. 7.

FIG. 7 is a diagram for explaining the plurality of pinching members 515 of the stiffness measuring apparatus 410.

As illustrated in FIG. 7, the plurality of pinching members 515 according to the present embodiment include pinching members 515A, 515B, and 515C. The pinching member 515A is arranged at a position closest to the lower end of the recording material S among the pinching members 515A, 515B, and 515C. The pinching force of the pinching member 515A acts in a direction parallel to the direction in which the presser 531 presses the recording material S.

The pinching member 515C is arranged at a position farthest from the lower end of the recording material S among the pinching members 515A, 515B, and 515C. The pinching member 515B is arranged between the pinching member 515A and the pinching member 515C. The pinching forces of the pinching members 515B and 515C act in directions crossing the direction in which the presser 531 presses the recording material S.

As illustrated in FIG. 7, in a state in which the recording material S is placed at the stiffness measurement position, a distance from a portion of the pair of holding rollers 521a and 521b of the pinching member 515A for pinching the recording material S to the lower end of the recording material S is set to a predetermined distance A. The predetermined distance A is preferably set in a range of 20 mm to 40 mm, for example.

The holding rollers 521a and 521b that are included in each of the pinching members 515A, 515B, and 515C and form a pair are formed of materials having the same hardness. As a material of the pairs of holding rollers 521a and 521b, for example, rubber, resin, or the like can be adopted. As a material of the pairs of holding rollers 521a and 521b, for example, ethylene-propylene-diene rubber (EDPM) having a hardness of 80° is preferable.

A general pair of conveying rollers is formed of different materials because it is not considered that a recording material S being conveyed is pressed in a direction intersecting the conveyance direction. In a case where such a pair of conveying rollers is adopted as the pair of holding rollers of the stiffness measuring apparatus according to the present invention, the recording material S may be displaced when the presser 531 presses the recording material S. As a result, the stiffness measuring apparatus cannot accurately measure the stiffness of the recording material S. On the other hand, the holding rollers 521a and 521b that form each pair according to the present embodiment are formed of materials having the same hardness. Therefore, even when the presser 531 presses the recording material S, each of the pairs of holding rollers 521a and 521b can pinch the recording material S so as not to shift the recording material S. As a result, the stiffness measuring apparatus can accurately measure the stiffness of the recording material S.

The holding rollers 521a and 521b that form each of the pairs in the pinching members 515A, 520B, and 520C have an equal diameter. Thus, the amount of deformation of the recording material S can be prevented from varying depending on the direction in which the presser 531 presses the recording material. As a result, the stiffness measuring apparatus can accurately measure the stiffness of the recording material S.

### Pinching Force of Pinching Member

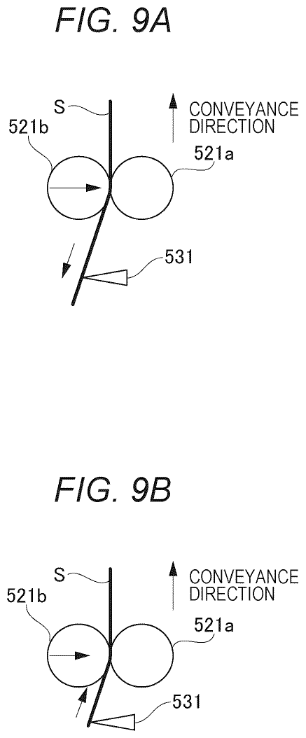

Next, the pinching force of the pinching member 515A will be described with reference to FIGS. 8, 9A, and 9B.

FIG. 8 is a diagram illustrating a state in which the presser 531 presses the recording material S when the pinching force of the pinching member 515A is not insufficient. FIG. 9A and FIG. 9B are diagrams illustrating a state in which the presser 531 presses the recording material S in a case where the pinching force of the pinching member 515A is insufficient.

As illustrated in FIG. 8, in the case where the pinching force of the pinching member 515A is not insufficient, even when the presser 531 presses the recording material S, the predetermined distance A does not change. Therefore, during the measurement of the reaction force of the recording material S, the effect of gravity does not change. As a result, the stiffness measuring section 512 can accurately measure the reaction force of the recording material S.

In the present embodiment, the pinching force of the pinching member 515A is set to an appropriate value, and the holding rollers 521a and 521b of the pinching member 515A that form a pair are formed of materials having the same hardness. Thus, the recording material S can be prevented from being shifted when the presser 531 presses the recording material S. As a result, even when the presser 531 presses the recording material S, the predetermined distance A does not change.

In a case where the pinching force of the pinching member 515A is insufficient, a friction force may be generated between the recording material S and the presser 531 when the presser 531 presses the recording material S, and the recording material S may be pulled out downward (see FIG. 9A). In this case, the predetermined distance A changes, and the effect of gravity changes during the measurement of the reaction force of the recording material S. As a result, the stiffness measuring section 512 cannot accurately measure the reaction force of the recording material S.

Further, in the case where the pinching force of the pinching member 515A is insufficient, when the presser 531 presses the recording material S, a friction force is generated between the recording material S and the presser 531, and the recording material S may be lifted upward (see FIG. 9B). Also in this case, similarly to the case illustrated in FIG. 9A, the predetermined distance A changes, and the effect of gravity changes during the measurement of the reaction force of the recording material S. As a result, the stiffness measuring section 512 cannot accurately measure the reaction force of the recording material S.

### Distance from Pinching Portion of Pinching Member to Lower End of Recording Material

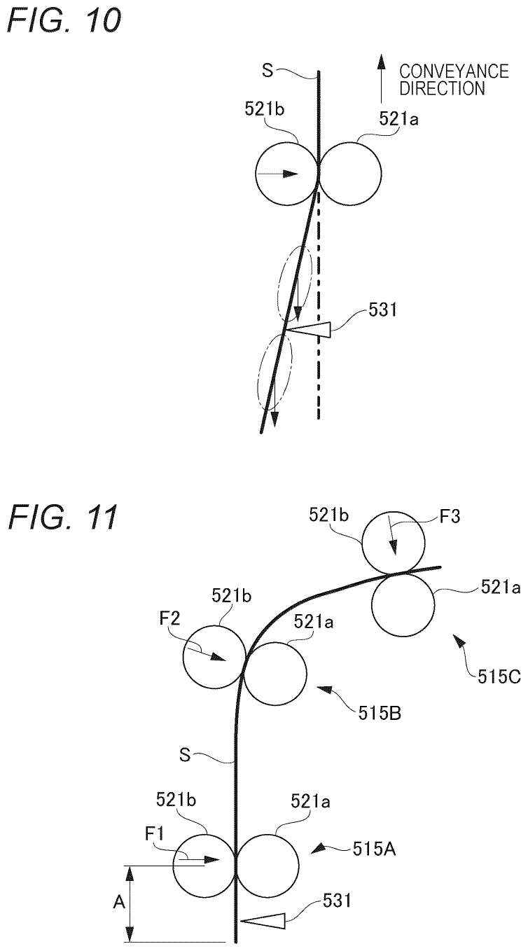

Next, a case where a distance from a pinching portion at which the pinching member 515A pinches the recording material S to the lower end of the recording material S is longer than the predetermined length A will be described with reference to FIG. 10.

FIG. 10 is a diagram illustrating a state in which the presser 531 presses the recording material S in a case where the distance from the pinching portion of the pinching member 515A to the lower end of the recording material S is equal to or longer than the predetermined length A.

As illustrated in FIG. 10, in the case where the distance from the pinching portion at which the pinching member 515A pinches the recording material S to the lower end of the recording material S is longer than the predetermined length A, the effect of gravity acting on the upper side and the lower side of the portion pressed by the presser 531 becomes large. Therefore, the stiffness measuring section 512 cannot accurately measure the reaction force of the recording material S.

As described above, in the present embodiment, the distance from the pinching portion at which the pinching member 515A pinches the recording material S to the lower end of the recording material S is set to the predetermined distance A. Therefore, the effect of gravity acting on the upper and lower sides of the portion pressed by the presser 531 is minimized. As a result, the stiffness measuring section 512 can measure the reaction force of the recording material S with high accuracy.

### Pinching Forces of Plurality of Pinching Members

Next, the pinching forces of the plurality of pinching members 515A, 515B, and 515C will be described with reference to FIG. 11.

FIG. 11 is a diagram illustrating pinching forces of the plurality of pinching members 515A, 515B, and 515C in the stiffness measuring apparatus 410.

As illustrated in FIG. 11, the pinching force F1 of the pinching member 515A is greater than the pinching force F2 of the pinching member 515G and the clamping force F3 of the pinching member 515C. That is, the spring force of the biasing spring 523 of the pinching member 515A is greater than the spring forces of the biasing springs 523 of the pinching members 515B and 515C.

When the recording material S reaches the stiffness measurement position, the controller 561 (see FIG. 6) controls the driving of each of the holding roller motors 524 for the plurality of pinching members 515A, 515B, and 515C and stops the rotations of the pairs of holding rollers 521a and 521b. Thus, the recording material S is stopped at the stiffness measurement position. In this case, the timings of stopping the pairs of holding rollers 521a and 521b in the plurality of pinching members 515A, 515B, 515C differ.

In the present embodiment, the pinching force FI of the pinching member 515A arranged at a position closest to the lower end of the recording material S is made greater than the pinching forces F2 and F3 of the other pinching members 515B and 515C. Thus, even when the timings of stopping the pair of holding rollers 521a and 521b in the plurality of pinching members 515A, 515B, and 515C differ, the recording material S can be prevented from being pulled and moved to the side on which the pinching members 515B and 515C are present. As a result, since the predetermined distance A does not change, the stiffness measuring section 512 can measure the reaction force of the recording material S with high accuracy.

### Parameter Setting Process

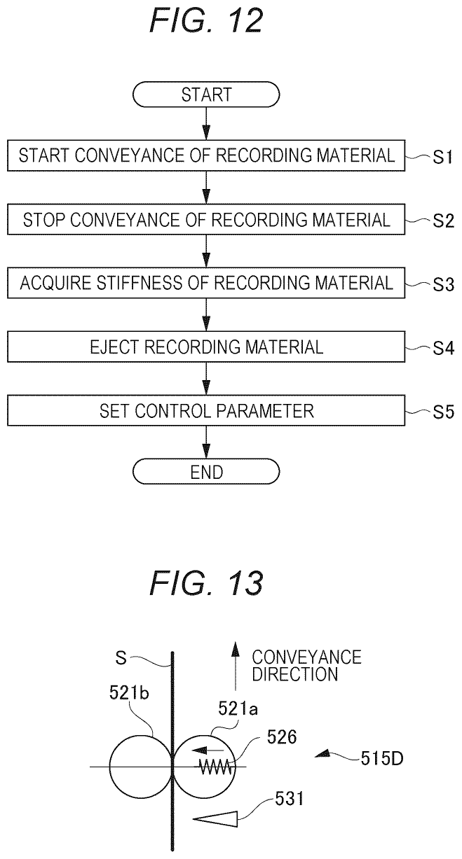

Next, a parameter setting process by the image forming system 10 according to the present embodiment will be described with reference to FIG. 12.

FIG. 12 is a flowchart illustrating a procedure of the parameter setting process by the image forming system 10.

First, when a print job is started, the conveyance controller 95 controls driving of the conveyance section 50 to take out a recording material S designated in the print job from the recording material supply section 70. Then, the conveyance controller 95 controls the driving of the first conveyance section 51 and the second conveyance section 52 to convey the recording material S along the second conveyance path 42 of the recording material conveyance apparatus 400 (S1).

Next, when the lower end of the recording material S is detected by the recording material detector 520 in the second conveyance path 42, the controller 561 of the stiffness measuring apparatus 410 controls the driving of the recording material holder 511 to stop the conveyance of the recording material S (S2). Thus, the recording material S is stopped at the stiffness measurement position. In step S2, the controller 561 stops driving the holding roller motors 524 for the plurality of pinching members 515A to 515C and causes the pairs of holding rollers 521a and 521b to pinch the recording material S placed at the stiffness measurement position.

Next, the controller 561 operates the stiffness measuring section 512 of the stiffness measuring apparatus 410 to measure the stiffness of the recording material S and acquires the stiffness (S3). In this case, the controller 561 causes the presser 531 to press the recording material S in the horizontal direction Y by controlling the driving of the recording material pressing motor 551. Then, the load measuring section 532 detects the load received from the recording material S pressed and bent by the pressing by the presser 531, and the controller 561 acquires the result of the detection. Next, the controller 561 sends the result of the detection as the stiffness of the recording material S to the controller 90 of the image forming system 10.

Next, the conveyance controller 95 controls the driving of the second conveyance section 52 to eject, from the ejection section 56, the recording material S whose stiffness has been measured (S4). In this case, the controller 561 drives the holding roller motors 524 for the plurality of pinching members 515A to 515C and releases the pinching of the recording material S by the pairs of holding rollers 521a and 521b.

Next, the controller 90 sets a control parameter based on the stiffness of the recording material S (S5). For the association of the stiffness of the recording material S and the control parameter, table data stored in the storage 98 in advance may be used. That is, the controller 90 reads the control parameter associated with the stiffness of the recording material S measured by the stiffness measuring apparatus 410 from the storage 98.

The control parameter to be set includes at least one of a conveyance parameter for the recording material, a curl correction parameter for the recording material, an image forming parameter, and a post-processing parameter.

A specific example of the conveyance parameter for the recording material is the speed at which the recording material is conveyed. Specific examples of the curl correction parameter for the recording material include a pressure applied to the recording material by a curl correction roller and a period of time when the curl correction roller contacts the recording material. Specific examples of the image forming parameter include a potential to be charged by the charger 242, a transfer current to be supplied to the primary transfer roller 245 and the secondary transfer roller 247, and a fixing temperature and a fixing pressure in the fixer 248. Specific examples of the post-processing parameter include driving pressure for stapling, driving torque for folding, and the like.

The conveyance parameter and the curl correction parameter are parameters set by the conveyance controller 95. The image forming parameter is a parameter set by the image forming controller 97. The post-processing parameter is a parameter set by a post-processing controller (not illustrated) included in the controller 90. The control parameter set in step S5 may be a control parameter other than the control parameters listed here.

### MODIFICATION EXAMPLES

Next, a modification example of each pinching member will be described with reference to FIG. 13.

FIG. 13 is an illustration of a modification example of the pinching member in the stiffness measuring apparatus.

As illustrated in FIG. 13, a pinching member 515D according to the modification example includes a pair of holding rollers 521a and 521b, a roller driving section 522 (sec FIG. 4), and a biasing spring 526. The pair of holding rollers 521a and 521b and the roller driving section 522 are the same as those of the pinching member 515A described in the present embodiment. The roller driving section 522 rotates the holding roller 521b.

The biasing spring 526 biases the holding roller 521a to the holding roller 521b side. A direction in which the biasing spring 526 biases the holding roller 521a is the same as a direction in which the presser 531 presses the recording material S. The pair of holding rollers 521a and 521b pinches the recording material S with a predetermined pinching force. The pair of holding rollers 521a and 521b pinches the recording material S in a posture in which the recording surface is substantially parallel to the vertical direction Z.

As described above, the direction in which the holding roller 521a is biased to generate the pinching force of the pinching member 515D and the direction in which the presser 531 presses the recording material S may be the same. Even in this case, the holding rollers 521a and 521b forming a pair are formed of materials having the same hardness. Therefore, even when the presser 531 presses the recording material S, the pair of holding rollers 521a and 521b can pinch the recording material S so as not to shift the recording material S. As a result, the stiffness measuring apparatus can accurately measure the stiffness of the recording material S.

The embodiments of the stiffness measuring apparatus and the image forming system according to the present invention have been described above, including the operations and effects thereof. However, the stiffness measuring apparatus and the image forming system according to the present invention are not limited to the above-described embodiments, and various modifications can be implemented without departing from the spirit and scope of the invention described in the claims.

In addition, the above-described embodiments have been described in detail in order to explain the present invention in an easy-to-understand manner, and the present invention is not necessarily limited to those including all the configurations described above. Further, a part of the configuration of an embodiment can be replaced with the configuration of another embodiment, and the configuration of an embodiment can be added to the configuration of another embodiment. Further, regarding a part of the configuration of each embodiment, it is possible to add, delete, and replace another configuration.

For example, in the image forming system 10 according to the above-described embodiment, the stiffness measuring apparatus 410 is provided in the recording material conveyance apparatus 400. However, the position where the stiffness measuring apparatus according to the present invention is provided can be appropriately set as long as the stiffness measuring apparatus is located upstream of the image former in the conveyance direction of the recording material. The stiffness measuring apparatus according to the present invention may be provided in, for example, the image forming apparatus 200 or the recording material supply apparatus 100.

Although embodiments of the present invention have been described and illustrated in detail, the disclosed embodiments are made for purposes of illustration and example only and not limitation. The scope of the present invention should be interpreted by terms of the appended claims.

What is claimed is:

1. A stiffness measuring apparatus comprising:
a pinching member that pinches a recording material such that a recording surface of the recording material is substantially parallel to a vertical direction;
a presser that presses the recording surface of the recording material pinched by the pinching member; and
a stiffness acquirer that measures a reaction force of the recording material when the recording surface of the recording member is pressed by the presser, and acquires the measured reaction force as stiffness of the recording material,
wherein portions of the pinching member that pinch the recording material are formed of materials having the same hardness.

2. The stiffness measuring apparatus according to claim 1, wherein a direction in which the pinching force of the pinching member acts is a direction perpendicular to the vertical direction.

3. The stiffness measuring apparatus according to claim 1, wherein a direction in which the pinching force of the pinching member acts is parallel to a direction in which the presser presses the recording surface of the recording material.

4. The stiffness measuring apparatus according to claim 1, wherein the pinching member pinches the recording material and stops the recording material at a predetermined position.

5. The stiffness measuring apparatus according to claim 4, wherein
when the recording material is at the predetermined position, a distance from the portions of the pinching member that pinch the recording material to a lower end of the recording material is a predetermined distance, and
the pinching member generates a pinching force to secure the predetermined distance when the presser presses the recording material.

6. The stiffness measuring apparatus according to claim 1, wherein the pinching member includes one or more pairs of rollers.

7. The stiffness measuring apparatus according to claim 6, wherein a pair of rollers closest to the presser among the one or more pairs of rollers has an equal diameter.

8. The stiffness measuring apparatus according to claim 6, wherein a pair of rollers closest to the presser among the one or more pairs of rollers has a greater pinching force than a pinching force of the other one or more pairs of rollers.

9. The stiffness measuring apparatus according to claim 6, wherein a width of a pair of rollers closest to the presser among the one or more pairs of rollers is longer than a width of the recording material.

10. An image forming system comprising:
an image former that forms an image on a recording material;
a recording material storage portion that can store the recording material;
a recording material conveyance section provided between the recording material storage portion and the image former;
a stiffness measuring apparatus that is installed in the recording material conveyance section and measures stiffness of the recording material; and
a controller that sets an image forming parameter in accordance with a result of the measurement by the stiffness measuring apparatus, wherein
the stiffness measuring apparatus includes:
a pinching member that pinches the recording material such that a recording surface of the recording material is substantially parallel to a vertical direction;
a presser that presses the recording surface of the recording material pinched by the pinching member; and
a stiffness acquirer that measures a reaction force of the recording material when the recording surface of the recording material is pressed by the presser, and acquires the measured reaction force as the stiffness of the recording material, wherein
portions of the pinching member that pinch the recording material are formed of materials having the same hardness.
